(19) United States
(12) Patent Application Publication
(10) Pub. No.: US 2016/0330797 A1
(43) Pub. Date: Nov. 10, 2016

(54) Electric Heating Mat

(71) Applicant: JR Bighorn Gustafson, Anchorage, AK (US)

(72) Inventor: JR Bighorn Gustafson, Anchorage, AK (US)

(21) Appl. No.: 14/706,822

(22) Filed: May 7, 2015

(51) Int. Cl. H05B 3/36; H05B 3/34

(52) U.S. Cl. CPC H05B 3/36; H05B 3/342

(57) ABSTRACT

An electrical heating system primarily comprising of electrical wire sandwiched between two layers of electrically insulating, heat conductive material and a thermostat for comfortably warming an animal especially newborn to keep high body temperature and blood temperature, to protect it against cold induced death. The thermostat allows shutting off the electrical heating system and prevents burning the animal. The electrical heating system is provided in different forms including a mattress. The electrical heating system is made up of sturdy yet soft material to survive the heavy weight of the animal and its hard body parts while providing cushioning effect allowing the animal to comfortably lie down and sleep. The electrical heating system provides right alignment to animal's vertebral column and spine. The electrical heating system is environmentally safe, recyclable, easily stored, nonflammable, and prevents entry of bugs inside it. The stains on the electrical heating system can be easily cleaned.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

1. Field of Invention

The present invention generally relates to an electrical heating system. More particularly, the present invention relates to “electrical heating system with an electrical wire sandwiched between two layers of electrically insulating, heat conductive material and a thermostat for providing safe and comfortable heat to animals”.

2. Background of Invention

Animal are important part of our society. Many animals are domestic pets. Cattles and many other animals serve important role by providing useful products and services for humans. Hence it is important to protect these animals against harsh weather which sometimes prove fatal. One very frequently encountering situation is cold weather such as faced during a freezing storm. During the cold weather it is important to maintain the body temperature thereby allowing proper blood circulation, proper working of digestive system and nervous system. Many times the pregnant animal suffers difficulties during deliver/process due to the cold weather and thereby resulting in miscarriage. After safe delivery during cold weather, it is important to keep the tongue, esophagus and teats of the mother animal warm and soft for proper feeding and functioning of digestive system. The newborn are highly sensitive to cold weather and need warm and soft teats for lactation. Also the body temperature of the newborn tends to become low very fast during cold weather leading to loss of life if the body temperature is not maintained quickly and for the time period till the newborn gain weight and survive through the cold weather. In other instance, the reproductive organs of the animal may also freeze during cold weather. In such case, the animal may move causing a damaging impact on the frozen reproductive organs thereby resulting in castration of the animal. Hence it is also required to safeguard the fertility of the animal.

There are mattresses, blankets, thermal linings available in the market for providing heat to the animal to save it from hypothermia. For example, U.S. Pat. No. 6,563,094 62 issued to Thermosoft International Corporation on 2003, May 13, discusses a soft electrical heater including electrically conductive threads or fibers as heating media encapsulated by insulating materials. The heater has continuous temperature sensors to prevent overheating and fire. The heater can be incorporated in blankets, throws, pads, mattresses, mats, bedspreads and carpets. Similarly, U.S. Pat. No. 6,770,854 B1 issued to Inotec Incorporated on 2004, Aug. 3, discloses an electric blanket with a heating element embedded through the blanket which heats the blanket upon receiving electric current. The electric blanket has a regulator to monitor heat and control delivery of electricity to the heating element. However, many of these heating materials suffer from one or more issues. It is desired that the mattress may be soft and provide cushion effect to the animal to give a comfortable platform. Furthermore it is desired that the mattress can handle pressure of heavy animals. Also, it will be beneficial if the mattress can be bend or easily stored when not in use. It is further useful if the mattress is environmentally safe and can be recycled. Due to its use with animals and newborn, it is important that the mattress can be easily cleaned to allow sanitary conditions. Normal bed mattresses suffers from problem that if they catch stains of feces, urine, body secretions, they are difficult to be cleaned. Also many mattresses harbor bugs and mosquitoes which when enter inside the mattress lay eggs and cause discomfort to the user by biting them. Most importantly, mosquitoes are carrier of many dangerous diseases including but not limited to malaria, dengue, and diseases caused by West Nile Virus. Similarly, some studies suggest that the bugs are carrier of some diseases including but not limited to diseases caused by pathogenic alphaviruses. Hence it is important that bed mattresses are built in a manner to prevent entry of the bugs and mosquitoes inside the bed mattresses. Another major issue with the bed mattresses is that these mattresses easily catch fire if someone throws a burning cigarette on it, thereby becoming a source of fire burning premises or buildings leading to death of occupants of the premises or buildings.

It is an aspect of the invention to overcome or alleviate a problem of the prior art.

This permits the use of the present invention which enhance the prior art of the electrical heating system for providing safe and comfortable heating to animals and provide an easy to dean and store, and safe heating system.

### BRIEF SUMMARY OF THE INVENTION

In view of the foregoing, one aspect of the various disclosed embodiments in the present invention is to provide an electrical heating system for providing sanitary and comfortable heating to animals.

Preferably the electrical heating system addresses, or at least ameliorates, one or more of the problems described above. To this end, the present invention related to an electrical heating system, with some unique aspects is disclosed.

Accordingly, it is a primary object of the present invention to provide an electrical heating system. The electrical heating system primarily comprises of electrical wire sandwiched between two layers of electrically insulating, heat conductive material and a thermostat for providing safe and comfortable heat to animals. The electrical heating system warms the animal to keep high body temperature and blood temperature, and protect them against cold induced death. The requirement of the electrical heating system may be during cold conditions including but not limited to deep freeze, ice storm, wet snow, ice, and frost etc. The thermostat in the electrical heating system allows shutting off the electrical heating system and prevents burning the animal.

It is another object of the present invention that the electrical heating system is a mattress to allow the animal to comfortably lie down and sleep.

It is yet another object of the present invention that the electrical heating system is made up of soft material to provide cushioning effect to the animal.

It is still another object of the present invention that the electrical heating system provides right alignment to animal's vertebral column and spine.

It is yet another object of the present invention that the electrical heating system is made up of sturdy material to survive the heavy weight of the animal and its hard body parts like hooves.

It is yet another object of the present invention that the electrical heating system prevents entry of bugs inside it thereby providing sanitary environment to the animal by preventing bug induced discomfort and illness.

It is still another object of the present invention that the electrical heating system can be easily cleaned. The stains of feces, urine, body secretions on the electrical heating system can be easily cleaned.

It is another object of the present invention that the electrical heating system can be easily storage. For this purpose the electrical heating system may be rolled up. In another aspect the electrical heating system can be provided with handle to move the electrical heating system out of the way by hanging it.

It is still another object of the present invention that the electrical heating system does not burn. It is important to prevent fire in the enclosure like house using the electrical heating system.

It is another object of the present invention that the electrical heating system is environmentally safe and can be recycled.

Other objects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 illustrates an electrical heating system in a human electrical blanket form.

### DETAIL DESCRIPTION OF THE INVENTION

The following detailed description of the present invention is enabling teaching of the invention and its best, currently known embodiment. Those skilled in the art can understand that many changes can be made in the embodiments described, while still obtaining beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made and may be desired in certain circumstances, and are part of the present invention. Thus, the following description is provided as illustrative of the principle of the present invention.

Embodiments of the present invention provide an electrical heating system. The electrical heating system primarily comprises of electrical wire sandwiched between two layers of electrically insulating, heat conductive material and a thermostat for providing safe and comfortable heat to animals. Accordingly, the specific embodiments discussed herein are merely illustrative of specific manners in which to make and use this invention, and are not intended to represent an exhaustive list of all possible structure and processes of the present invention.

Embodiments of the method are shown in the figures, and discussed below. While the structure and processes have been described with a certain degree of particularity, it is to be noted that many modifications may be made in the details of the structure and processes without departing from the spirit and scope of this disclosure. It is understood that the structure and processes are not limited to the embodiments set forth herein for purposes of exemplification,

Aspects of the present inventive subject matter are described with reference to the figures provided herein.

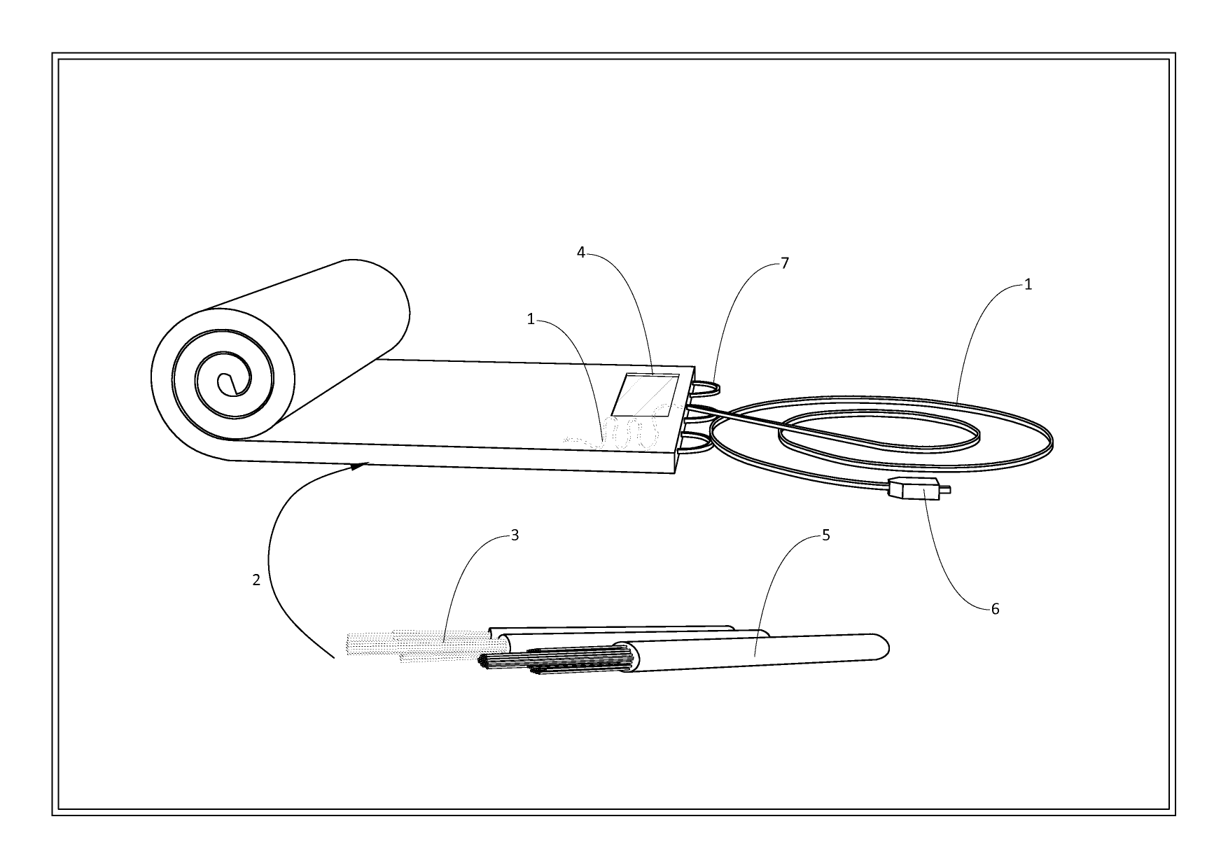

Referring to FIG. 1 which shows a representation of an electrical heating system, according to a preferred embodiment of the present invention, the electrical heating system has an electrical wiring 1 sandwiched between two layers of electrically insulating 2, heat conductive material 3, and a thermostat 4 for providing safe and comfortable heat to animals. The electrical wiring is present throughout the layers of the electrically insulating, heat conductive material, preferably in a circular (round pattern) 5 as shown in the figure. However, the electrical wiring may be present throughout the layers of the electrically insulating, heat conductive material in any possible pattern. It is preferred that the electrical wiring is present in the middle of the electrical heating system. The electrical wiring extends out of the electrical heating system and connects to a power source 6. When the power source is switched on to run the current through the electrical wiring present inside the electrical heating system, the electrical wiring due to its resistance generates heat. The heat generated in the electrical wiring is spread throughout the layers of the electrically insulating, heat conductive material. The electrically insulating, heat conductive material due to its properties does not allow electric current to reach the top and bottom surfaces of the electrical heating system, thereby preventing any event of electrocution. Furthermore the material allows the heat generated by the electrical wiring to reach the surface of the electrical heating material, thereby providing safe and comfortable heat to animals. The thermostat in the electrical heating system maintains a desired temperature by monitoring the temperature in the electrical heating system and shuts off and powers on the electrical heating system to prevent discomfort due to potentially harmful high range of temperature.

The electric wiring of the electrical heating system must be able to transfer temperature only a specific Fahrenheit degrees above the actual normal temperature which is comfortable to the animal. The thermostat allows the user to set the required comfortable temperature according to the need of the animal using the electrical heating system. Temperature cannot go beyond the set comfortable temperature to avoid burning effect to animal.

The electrically insulating, heat conductive material present as layers in electrical heating system is preferably made up of, but not limited to, rubber or foam. In one aspect of the present invention, out of the two layers of the electrical heating system, the lower layer of the electrically insulating material is nonconductive to heat. The material is soft and provides cushion to the animal thereby preventing any hard shock to bones or joints, broken bones or injuries to body parts. In one of the preferred embodiments of the present invention, the material keeps the vertebral column and spine of the animal in right alignment. Furthermore the material can preferably be bent to roll up to allow easy storage.

The electric wiring of the electrical heating system is preferably in the middle of the electrical heating system i.e. when the electrical heating system is 4 inches thick, the wiring is at 2 inches height from base and when the electrical heating system is 6 inches thick such as for supporting animals weighing up to 2000 pounds, the wiring is at 3 inches height from the base.

Again referring to the FIG. 1, the electrical wiring comes out of the electrical heating system in the form of a power cord (electrical cord) preferably through a plastic pipe 7 extending to connect to a power source. The plastic pipe may preferably be made of PVC. The PVC plastic pipe is intended to prevent the animal from smelling, tasting or biting on the electrical cord extending out of the electrical heating system, damaging it or suffering harm himself. Furthermore, the power cord preferably connects to 220 volts.

The electrical heating system is designed to handle the pressure of light weight newborn as well as heavy weight of a heavy animal weighing up to 2000 pounds (1 ton). It can be used for pawed animals as well as massive hoofed animal. The electrical heating system is sturdy to support the hooves and paws of a heavy animal. Some of the examples of the animals for which the electrical heating system can be used include, but not limited to dog, cat, horse, beef, Black angus, Red angus, Simmental cattle, Limousin cattle, Hereford cattle, and Beef master etc.

The surface of the electrical heating system can be easily cleaned. Hence, if the electrical heating system catches stains of feces, urine or body secretions, it can be easily wiped with a cloth. The surface of the electrical heating system is applied with water and cleaning detergent such as, but not limited to Clorox or Lysol etc. Next, soft bristle push broom can be pushed on the surface to remove contamination from surface. The liquid fallen on the surface of the electrical heating system does not leave any stain as it can be easily wiped off. This makes it better than fabric and cloth based systems.

The electrically insulating, heat conductive material present as layers in electrical heating system is nonflammable and hence does not burn. Hence event like contact with a burning cigarette does not damage it and does not make the electrical heating system a source for house fire.

The electrical heating system may take any form. It may be a mat for allowing the animal to sleep comfortably at a warm body temperature. It may be a mat for door way entrance to allow feet to step on wherein the heated mat will have no ice or snow on it. It may also be a blanket as shown in FIG. 1 as an example of a human electrical blanket. As can be seen in the figure, the power cord coming out of the mat connects to a 220 volts socket. Furthermore the thermostat is connected to the power cord to regulate the temperature provided to the animal.

Referring to the FIG. 1, the electrical heating system may preferably have at least one handle. The at least one handle may be present at one side of the electrical heating system. The handle may be used to hang the electrical heating system out of the way when it is not in use to provide convenient storage. The handle is strong to support the weight of the electrical heating system. In one of the preferred embodiments of the present invention, the handle can be used fasten the electrical heating system in its position so that animal cannot move the mat out of the position. The power cord of the electrical wiring may be preferably connected to a power source positioned on nearby wall.

Referring to FIG. 1, the electrical wiring exits the electrical heating system on the side of the electrical heating system to connect to the power socket on the wall. The electrical heating system has its two layers of the electrically insulating, heat conductive material joined together preferably by electronic wielding. The electronic wielding joins the two layers without leaving any gap. Hence the bugs and other insects like mosquitoes cannot enter inside the electrical heating system. Thus the bugs may not live inside and lay eggs. Thus the electronic wielding prevents bugs related issue.

The electrical heating system can be developed in different sizes for different use. It can be used for animals as well as humans. The electrical heating system is intended for use by newborn, pre-term infant, an infant, a child, a teenager and an adult. The electrical heating system is intended to be provided in sizes so that it can even cover the whole area of an animal or human of all age groups. For using the electrical heating system with livestock animals, the size of the electrical heating system accommodates the length of livestock animals (like beef, bulls, cows, calves, horses, colts, fillies) from nose to tail. For supporting animals weighing up to 2000 pounds, the thickness of the electrical heating system is preferably 6 inches. For use by human, the thickness of the electrical heating system is preferably 4 inches. An exemplary electrical heating system for supporting animals weighing up to 2000 pounds. The length varies from 10 inches to 18 feet, the width from 10 inches to 108 inches with thickness from 4 to 6 inches. The small sized electrical heating systems can be used for specific requirements such as under the table in office.

The electrical heating system can be specifically used for newborns to provide the newborn the desired body temperature, keep blood circulation and prevents the hypothermia induced sickness in them. The use of electrical heating system during the delivery of a pregnant animal the movement of the animal is minimized to reduce the chances of miscarriage. In certain conditions, the electrical heating system is intended to keep the frost off the tongue, esophagus and teats of the animal so as to allow the lactation of the newborn by keeping teats warm and soft. This further keeps the digestive system as well as nervous system of the animal and the newborn in operation. In certain conditions, the electrical heating system is intended to keep the frost of the reproductive organs of the animal to prevent accidental castration caused by the sudden movement of the animal causing damaging impact on the frozen reproductive organs. The electrical heating system is highly useful in conditions like subzero conditions where the temperature goes even up to minus 40 degrees F. In these conditions, the electrical heating system keeps the temperature of a newborn or an animal at comfortable body temperature and prevents their death due to pneumonia, flu or other disease conditions due to cold weather. This is very useful to reduce mortality rate of newborn as they are highly sensitive to cold weather.

The electrical heating system in preferred embodiments can be configured to meet specification of health department or other regulatory authorities for specific use in but not limited to hospitals, cattle farms, military camps, hotels, household and hostels etc.

The electrical heating system is intended to be recycled. Once the electrical heating system wears out of time, it shall be dismantled to remove wiring, thermostat and the electrically insulating, heat conductive material to recycle them. Hence the electrical heating system is environmentally safe.

It is to be understood that the above description is intended to be illustrative, and not restrictive. For example, the above discussed embodiments may be used in combination with each other. Many other embodiments will be apparent to those of skill in the art upon reviewing the above description.

Whereas, the structure and processes have been described in relation to the figures of the drawings, it should be understood that other and further modifications, apart from those shown or suggested herein, may be made within the spirit and scope of this invention.

I claim:

1. An electrical heating system comprising:
at least two layers of electrically insulating, heat conductive material;
an electrical wiring sandwiched between said layers of electrically insulating, heat conductive material, wherein the electrical wiring generates heat on passing electric current through said electrical wiring to spread heat through the layers of the said electrically insulating, heat conductive material; and
a thermostat for maintaining desired temperature in said electrical heating system.

2. The electrical heating system of claim 1, where said electrical wiring is present throughout the layers of said electrically insulating, heat conductive material.

3. The electrical heating system of claim 1, wherein said electrical wiring is present in circular pattern.

4. The electrical heating system of claim 1, wherein said electrical wiring is present in middle layer of the electrical heating system.

5. The electrical heating system of claim 1, wherein said electrical wiring extends out of the electrical heating system and connects to a power source.

6. The electrical heating system of claim 1, wherein said electrical wiring extending out of the electrical heating system is covered with a plastic pipe.

7. The electrical heating system of claim 1, wherein said electrical wiring is covered by a plastic PVC pipe.

8. The electrical heating system of claim 1, wherein the electrical heating system further comprises at least one handle.

9. The electrical heating system of claim 1, wherein the electrically insulating, heat conductive material is nonflammable.

10. The electrical heating system of claim 1, wherein the electrically insulating, heat conductive material is rubber or foam.

11. The electrical heating system of claim 1, wherein said at least two layers of the electrically insulating, heat conductive material are joined together by electronic wielding.

12. The electrical heating system of claim 1, wherein the electrical heating system is a mat for sleeping on.

13. The electrical heating system of claim 1, wherein the electrical heating system is a mat for door entrance.

14. The electrical heating system of claim 1, wherein the electrical heating system is a human electrical blanket.

15. The electrical heating system of claim 1, wherein the electrical heating system is 4 to 6 inch thick.

16. The electrical heating system of claim 1, wherein the electrical heating system provides safe and comfortable heat to an animal up to 2000 pounds.

17. The electrical heating system of claim 20, wherein the electrical heating system is from 1 inches to 18 feet long and from 10 inches to 108 inches wide.
